(19) United States
(12) Patent Application Publication
(10) Pub. No.: US 2008/0215384 A1
(43) Pub. Date: Sep. 4, 2008

(54) Negotiated Reservation for Vacation Rental Homes

(76) Inventors: Todd R. Mulholland, Austin, TX (US); Christine M. Bolding, Dallas, TX (US); Joseph William Nicholson, Fairview, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/971,019

(22) Filed: Jan. 8, 2008

Related U.S. Application Data
(60) Provisional application No. 60/883,902, filed on Jan. 8, 2007.

(51) Int. Cl. G06Q 30/00; G06Q 10/00

(52) U.S. Cl. 705/5

(57) ABSTRACT

System and method for reserving and booking vacation rental properties. The method may include receiving first user input from a first user to a website requesting reservation of a vacation rental property. The first user input may include contact information. The method may further include providing the first user input to a second user regarding the requested reservation of the vacation rental property. The contact information may be usable to contact the first user. The method may include receiving second user input specifying a reservation of the vacation rental property. The reservation may include reservation dates and a reservation price. The reservation may be provided to the first user, and payment information may be received for the reservation.

### PRIORITY CLAIM

The application claims priority to provisional application Ser. No. 60/883,902 titled “Negotiated Reservation for Vacation Rental Homes” filed on Jan. 8, 2007, whose inventors are Todd Mulholland, Chris Bolding, and Bill Nicholson, and which is hereby incorporated by reference in its entirety as though fully and completely set forth herein.

### FIELD OF THE INVENTION

The invention relates generally to vacation rental homes, and more specifically, to a system and method for negotiated reservation of vacation rental homes.

### DESCRIPTION OF THE RELATED ART

Vacation rental property owners currently face many logistical problems in advertising their properties, locating and communicating with potential customers, and payment and booking of customers. The Internet has aided in facilitating many of these problems. For example, many websites currently list hundreds of vacation rental properties which may be viewed by potential customers using Internet browsers (such as for example, Internet Explorer™, Firefox™, Opera™, Safari™, etc.). However, these websites generally do not assist the owners and customers in booking and payment of the vacation rental properties. Thus, improvements in online reservation and booking methods for vacation rental properties are desired.

### SUMMARY OF THE INVENTION

Various embodiments are disclosed of a system and method reserving and booking vacation rental properties.

In one embodiment, the method may comprise receiving first user input to a website requesting reservation of a vacation rental property, wherein the first user input comprises contact information for the first user. In other words, a first user may access a website and request a reservation of a vacation rental property. In making the reservation request, the first user may provide his contact information.

The first user input regarding the requested vacation rental property reservation may then be provided to a second user, e.g., the owner or manager of the vacation rental property. The contact information is usable by the second user (e.g., the owner or manager) to contact the first user regarding the reservation.

The method may then receive second user input (e.g., from the second user) specifying a reservation of the vacation rental property after said providing the first user input to the second user, wherein the reservation comprises reservation dates and a reservation price. For example, the second user (the vacation rental property owner or manager) may use the first input to specify or create a reservation, possibly including dates for the reservation and pricing, etc. The second user (owner or manager) may use the first user input requesting the reservation to determine one or more of pricing information of the reservation, screening information of the first user, a credit score of the first user, and/or demographic information.

The reservation may then be provided to the first user. A payment request for the reservation may be stored in a memory medium, wherein the payment request is usable for payment of the vacation rental property. For example, the second user (e.g., the owner or manager) may create the payment request for the reservation. The payment request may then be provided to the first user to receive payment for renting the vacation rental property. In other words, the first user may receive the payment request and then make a payment for the vacation rental property in response to the payment request.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a system operable to execute a business process according to an embodiment of the present invention;

FIGS. 2-4 are exemplary block diagrams illustrating exemplary methods of the present invention; and

FIGS. 5-10 are exemplary screen shots of webpages which may implement methods of the present invention.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Program or Software Program—the terms “program” or “software program” are intended to have the full breadth of their ordinary meaning, and include any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements. A GUI may comprise a single window having one or more GUI Elements, or may comprise a plurality of individual GUI Elements (or individual windows each having one or more GUI Elements), wherein the individual GUI Elements or windows may optionally be tiled together.

Graphical User Interface Element—an element of a graphical user interface, such as for providing input or displaying output.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Subset—in a set having N elements, the term “subset” comprises any combination of one or more of the elements, up to and including the full set of N elements. For example, a subset of a plurality of icons may be any one icon of the plurality of the icons, any combination of one or more of the icons, or all of the icons in the plurality of icons. Thus, a subset of an entity may refer to any single element of the entity as well as any portion up to and including the entirety of the entity.

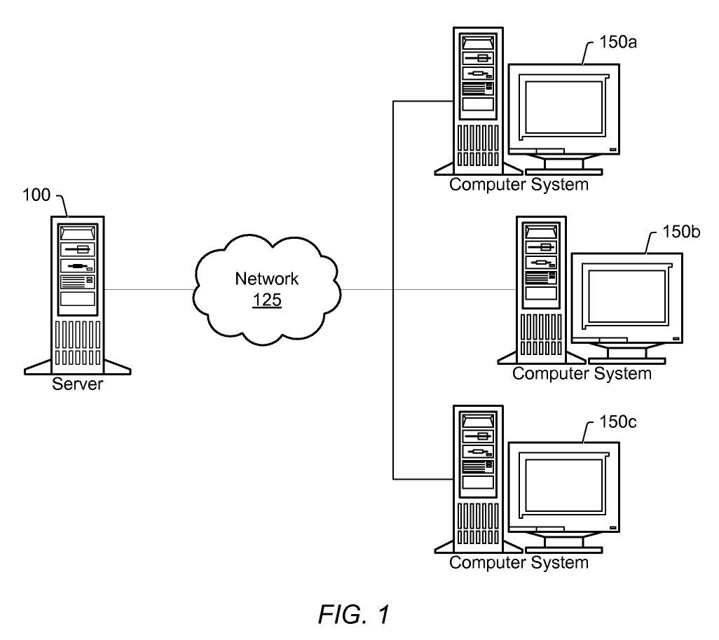

### FIG. 1—Exemplary Server/Client System

FIG. 1 illustrates an exemplary server/client server system operable to implement the methods described herein. More specifically, as shown, server system 100 may couple to computer systems (e.g., clients) 150a, 150b, and 150c (referred to as computer systems 150) via network 125. As shown, the computer systems 150a, 150b, and 150c and the server system 100 may include display devices, e.g., for displaying various graphical user interfaces (GUIs) such as those described herein. More specifically, the display devices may be operable to display GUIs of programs or instances executing on the server 100. The GUIs may comprise any of various types of graphical user interfaces, e.g., depending on the computing platform.

In one embodiment, the server 100 may execute webserver software, and the server 100 may present various GUI displays to various ones of the client computers 150. In this embodiment, the various client systems 150 may simply execute web browser software (such as those web browsers described above, among others) to view the GUIs. Alternatively, in another embodiment, the client computers may operate in a stand-alone non-web based mode.

The server 100 and/or the computer systems 150 may include at least one memory medium on which one or more computer programs or software components according to one embodiment of the present invention may be stored. For example, the memory medium may store one or more programs which are executable to perform the methods described herein. The memory medium may also store operating system software, as well as other software for operation of the computer system. Various embodiments further include receiving or storing instructions and/or data implemented in accordance with the foregoing description upon a carrier medium.

The server 100 may comprise one physical server computer that implements one or more logical servers. Alternatively, the server 100 may comprise two more different physical servers that may be connected together, e.g., over a LAN or WAN.

The network 125 can be any of various types, including a LAN (local area network); a WAN (wide area network), such as the Internet; or an Intranet, among others. The computer systems 150 and the server 100 may execute programs in a distributed fashion. For example, one or more of the computer systems 150 may execute a first portion of a program (e.g., a client program, applet, or other executable portion) and server 100 may execute a second portion of the program (e.g., a server program which hosts the applet or executable portion). As another example, one or more of the computer systems 150 may display a GUI of a program (e.g., in a browser) which may be mostly executing on the server 100.

### Online Reservation

Various embodiments are disclosed of a system and method reserving and booking vacation rental properties. Note that the various steps described below may be performed in a different order or omitted entirely. Additionally, further steps may be included in the method as desired.

As described above, various vacation rental properties may be provided via a network such as, for example, the Internet. In some embodiments, similar to embodiments described above regarding FIG. 1, the vacation rental properties may be described and provided by a webserver (such as the server 100) to various client machines (such as computer systems 150). A user (e.g., a potential customer) may browse these vacation rental properties provided by the webserver using an Internet browser (e.g., Internet Explorer™, Firefox™, Safari™, Opera™, etc.). The webserver may provide one or more websites and/or webpages for each (or for a collection of) vacation rental property. For example, the webpages may include pictures of the vacation rental property and associated descriptions (e.g., textual descriptions) which may allow the user to fully appreciate and understand the vacation rental property that he or she may be interested in renting. The webpages may also include pricing information (e.g., rates over time, such as, for example, weekly rates, daily rates, etc.), available times (e.g., in the form of a calendar), contact information, and/or other information. Thus, in some embodiments, the webserver may provide information allowing users to locate vacation rental properties and begin a reservation process with the owners or managers of the property.

If the user decides to begin the reservation process for a particular vacation rental property, a variety of different paths may be available. For example, in one embodiment, the user may simply be able to select desired vacation dates (e.g., from the available dates displayed on a calendar, for example), enter a payment method (e.g., credit cards, online payment methods such as, for example, PayPal™ or Google Checkout™, escrow accounts, banking account information, future payment plan methods, and/or other methods), and confirm the booking immediately.

In some embodiments, the owners or managers of the property may desire to obtain more information regarding the potential renter before accepting the reservation. Additionally, the user (the potential renter) may want to discuss the vacation reservation with the owner or manager in order to negotiate rates or discuss the particular details of the planned vacation. For example, an owner (or manager) may decide not to rent the property to a college athletic team, or to college-aged renter, due to fears of damage to the property. Additionally, the owner may need more information regarding the reservation, e.g., regarding number of occupants, required amenities/scheduling, etc. It may be important that the owner or manager find more information in order to choose between two or more potential customers, e.g., to maximize revenue and/or minimize costs. Alternatively, or additionally, the user may need or want to discuss details of the possible vacation rental with the owner or manager. For example, the user may need to inquire about availability, rates, amenities, locations, proximities to other activities or places, etc. As a specific example, the user may want to rent the vacation property for four days of a week when rates are only shown (e.g., on the webpage for the particular vacation rental property) for a full week or weekend. In these cases, it may be more desirable to put the user and the owner in contact before finalizing pricing and booking of the vacation rental property.

In some embodiments, the user may complete a form that includes information described above, such as contact information and/or desired booking dates, and this information may be provided to the manager or owner (referred to as “owner”). The user may at this point also enter in payment information, e.g., using a form on the webpage; however, in some embodiments, the user may (e.g., instead) enter payment information upon finalization of the reservation/booking. In response to the user entering the contact information and/or desired booking dates, the owner may receive a notification of this information (e.g., via email, instant messaging, telephone, fax, postal mail, etc.) and may, for example, log on to the website to view the requested reservation. However, in some embodiments, the indication may include the information entered by the user, and the owner may need to create a new reservation, e.g., using the website (e.g., stored on the server 100). The owner may then have the ability to review the requested reservation (e.g., automatically entered by the website or manually entered by the manager) and make changes to the reservation as desired.

In some embodiments, as indicated above, the owner may choose to contact the user to negotiate rates or dates or to discuss further the details of the reservation before making these edits. The owner may also choose to contact the user to personally screen the user, e.g., to make sure the user is reputable and will not harm the vacation property, and/or is financially able to perform the transaction. In some embodiments, the website may use the contact information entered by the user to perform screening tasks for the owner (e.g., as specified by the owner). For example, the website may automatically (i.e., without requiring direct user input performing the task) perform background checks, retrieve credit rating reports, retrieve educational background information, retrieve criminal record information, determine whether the user has sufficient funds for the requested reservation, determine other credit or financial information associated with the user, and/or other information that the owner may use to decide whether or not to rent the property to the user. Alternatively, the website may direct the owner to websites for performing various ones of these tasks (among others).

In some embodiments, the owner may be able to set up a payment schedule for the reservation. For example, the owner may require an initial payment for the reservation, damage deposits, or other payments. The owner may also configure payments scheduled upon arrival (or some period before) as well as final payments (e.g., for damaged property, cleaning fees, etc.). In some embodiments, the owner may be able to set up template payment schedules and may select from a list of the templates for the reservation. In one embodiment, the payment schedules may be sent out automatically by the website, e.g., according to a preferences set by the user, owner, and/or website. For example, the website may automatically send out a reminder a week before the payment is due and every 2 days until the transaction is completed (among other periods, schedules, etc.).

Additionally, the reservation/booking information may also include other information regarding rentals, fees, services, etc. For example, the reservation or booking information may include flight costs, rental car flights, excursion fees, cleaning fees, transaction fees, etc. Additionally, the booking information may include information regarding policies, rates and extra charges, reservation guarantees, etc. Thus, using the methods described herein, the owner may fully specify booking and reservation information for the user.

Upon screening the user, contacting the user to determine more information, editing the reservation information, and/or other steps to create the reservation/booking information for the user, the owner or manager may send the booking information and/or a request for payment to the user. Correspondingly, the user may choose to accept the reservation/booking and initiate payments via the variety of methods described above, among others. Thus, the method may allow the owner and user to negotiate prices and/or details of the reservation and complete booking and/or payment of the reservation online.

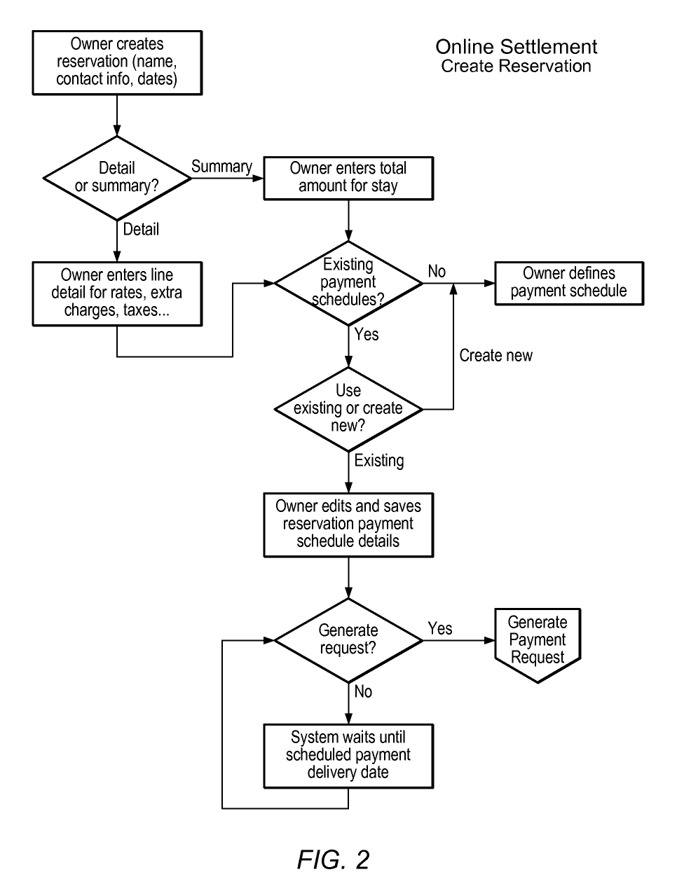

### FIG. 2—Flowchart for Reservation Creation

FIG. 2 is a flowchart illustrating an exemplary method for creating reservation and payment requests. Note that the various steps described below may be performed in a different order or omitted entirely. Additionally, further steps may be included in the method as desired.

As shown, the owner may create a reservation. As discussed above, the owner may created a reservation in response to a user (“traveler”) entering information on a website expressing interest in the owner's vacation property and providing the user's contact information. The owner may receive the user contact information and requested travel dates and create the reservation. The reservation may include the name of the user, contact information, dates of the reservation etc.

In creating the reservation, the owner may create a detailed or summary payment request. For the summary payment request, the owner may simply enter a total amount required for the stay of the user. In a detailed payment request, the owner may enter line item detail for various rates, extra charges, taxes, services, fees, etc. The payment request is designed to be transmitted to the user (“traveler”) as a request for payment for use of the vacation property.

The owner may either use an existing payment schedule (e.g., using the templates described above) or define a new payment schedule. As indicated above, the payment schedule may specify when payments should be requested/received and/or when the payment requests should be sent to the user.

Finally, a payment request may be generated according to the owner or according to the payment schedule (among others) as desired.

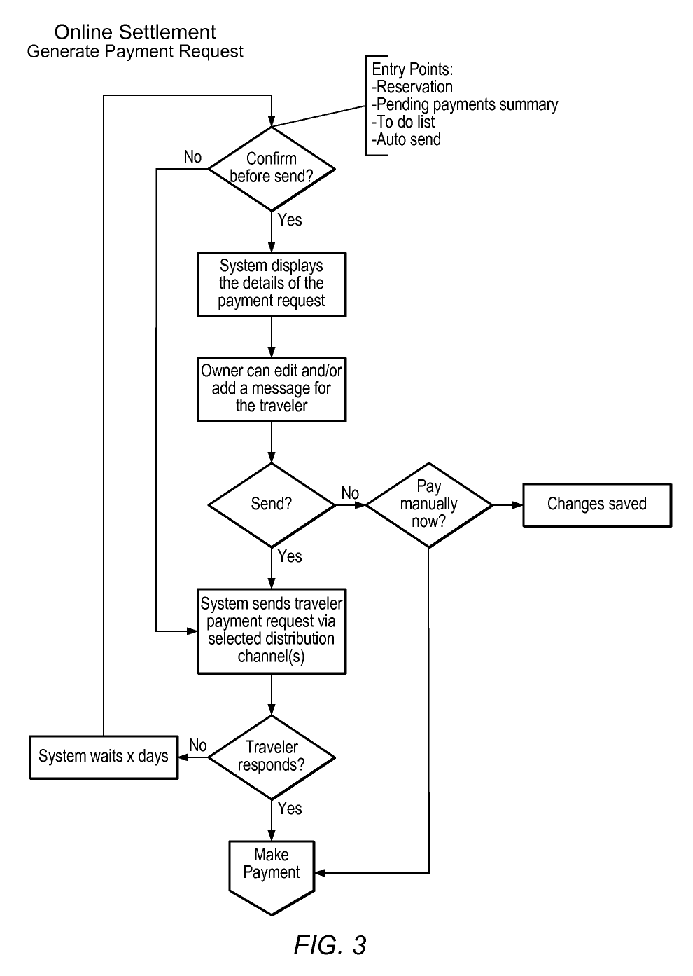

### FIG. 3—Flowchart for Sending Payment Request

FIG. 3 is a flowchart illustrating an exemplary method for sending a payment request. Note that the various steps described below may be performed in a different order or omitted entirely. Additionally, further steps may be included in the method as desired.

The method of FIG. 3 may begin from the entering of reservation information (e.g., according to the methods described above), a pending payments summary (e.g., a webpage on the website), a to do list (e.g., a webpage on the website), or in an automated auto send method (e.g., according to website, owner, or user preferences/settings).

As shown, before sending a payment request (e.g., generated according to the methods described above), the owner may confirm transmittal of the payment request. This may allow the owner to verify that the payment request should be sent and/or allow the owner to make changes to the request.

If confirmation is required, the system may display the details of the payment request, and, as indicated above, make changes and/or add a message for the traveler/user. Upon confirming the payment request (or if confirmation is not required), the system may send the payment request to the user via the selected distribution channel(s). If the traveler responds, the method may continue to receive payment from the user. If the traveler fails to respond, the system may wait for a period of time and start the process over again.

As also shown, if the owner chooses, instead of sending a payment request, the owner may “pay manually” (e.g., entering information possibly already received from the user via alternative means). In this case, the changes to the reservation may be saved.

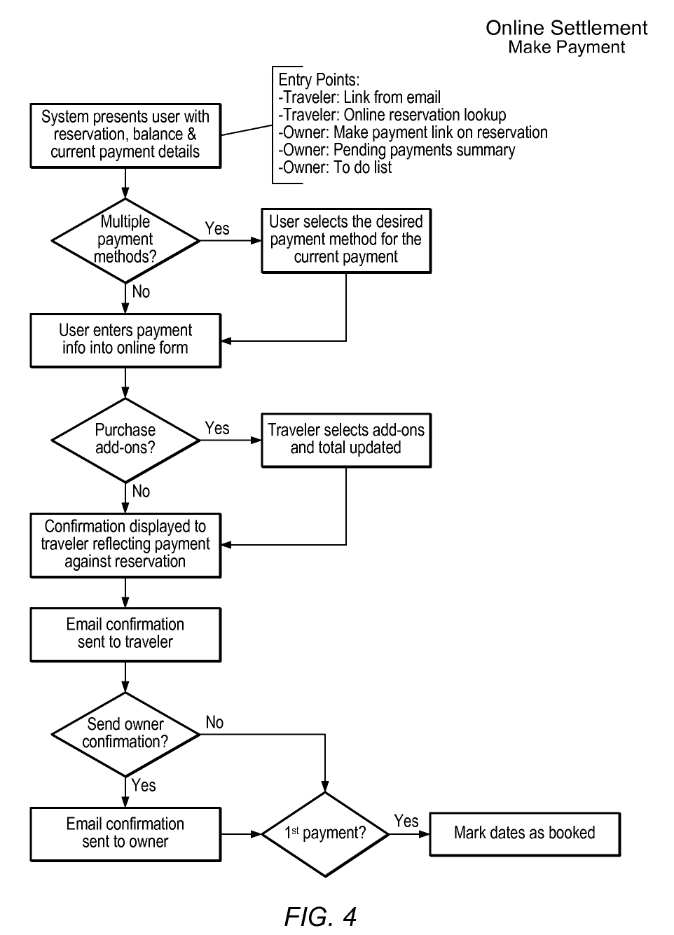

### FIG. 4—Flowchart for Online Settlement

FIG. 4 is a flowchart illustrating an exemplary method for making a payment. Note that the various steps described below may be performed in a different order or omitted entirely. Additionally, further steps may be included in the method as desired.

The method of FIG. 4 may begin from the user following an email link or an online reservation lookup (e.g., via the website). Alternatively, the owner may access this method from a make payment link (e.g., on the website), a pending payments summary (e.g., on the website), and/or a todo list (e.g., on the website), among others.

As shown, the system may present the user and/or owner with the reservation, balance, and current payment details. If there are multiple payment methods, the user may select the desired payment method for the current reservation and/or payment. In either case, the user enters the payment info in an online form (e.g., on the website). If the user wishes to purchase add-ons, the user may select the add-ons and the total may be updated.

Subsequently, confirmation reflecting payment against reservation may be displayed to the user, and the confirmation may be sent to the traveler. If desired, confirmation may be sent to the owner, e.g., via email. Additionally, if this is the first made payment, the date may be marked as “booked”, e.g., in the reservation on the website.

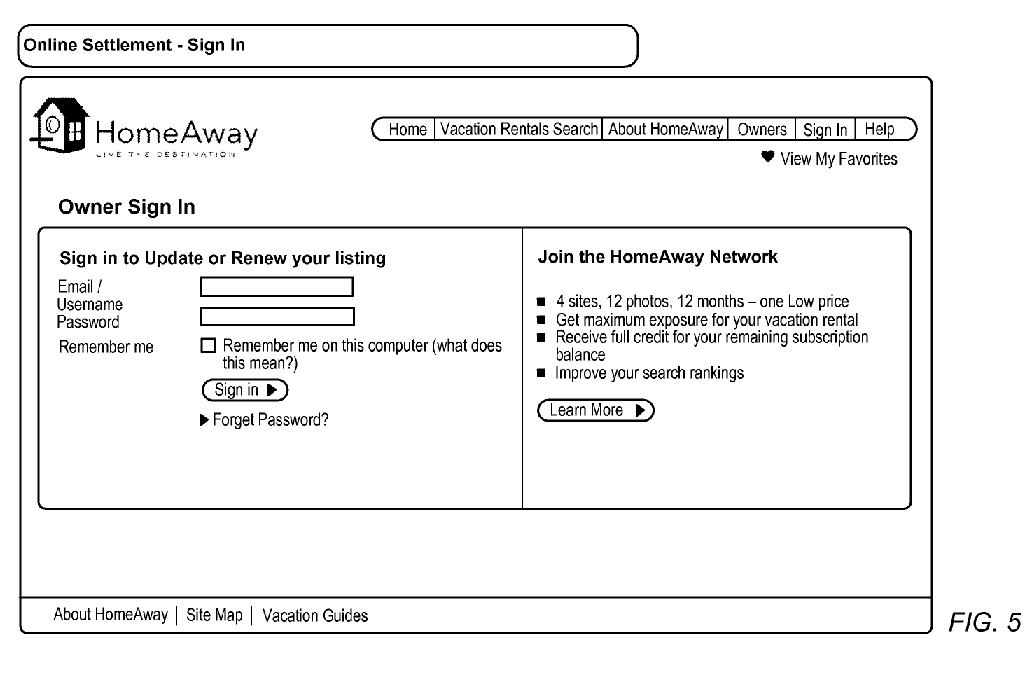

### FIGS. 5-10—Walk-Through of Exemplary Method for Reservation and Booking

FIGS. 5-10 are screen shots illustrating a walk-through of an exemplary method for reservation and booking according to one embodiment of the present invention.

FIG. 5 is an exemplary login page for the website.

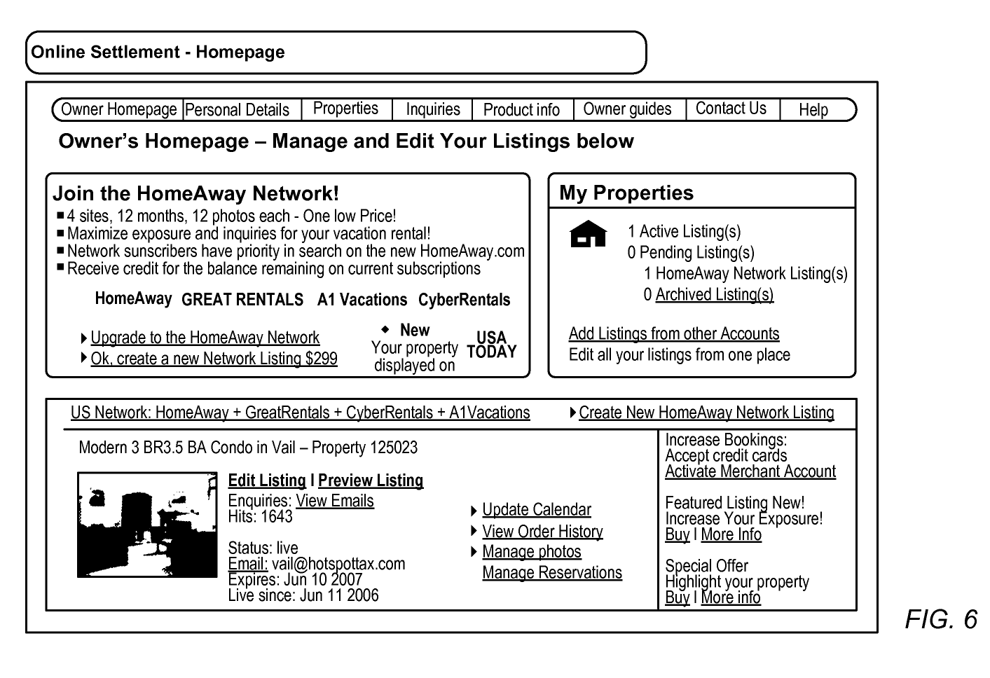

FIG. 6 is an exemplary webpage for managing properties. As shown, the owner/manager may be able to select a “manage reservations” link.

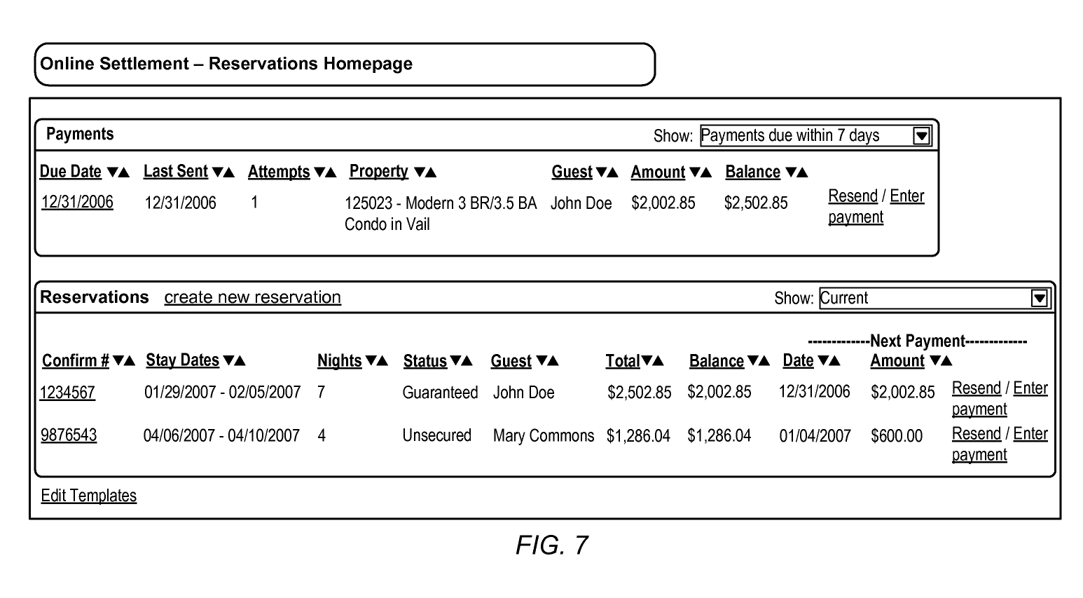

FIG. 7 is an exemplary reservations homepage for an owner or manager using the website. As shown, the owner may manage payments and/or reservations using this webpage.

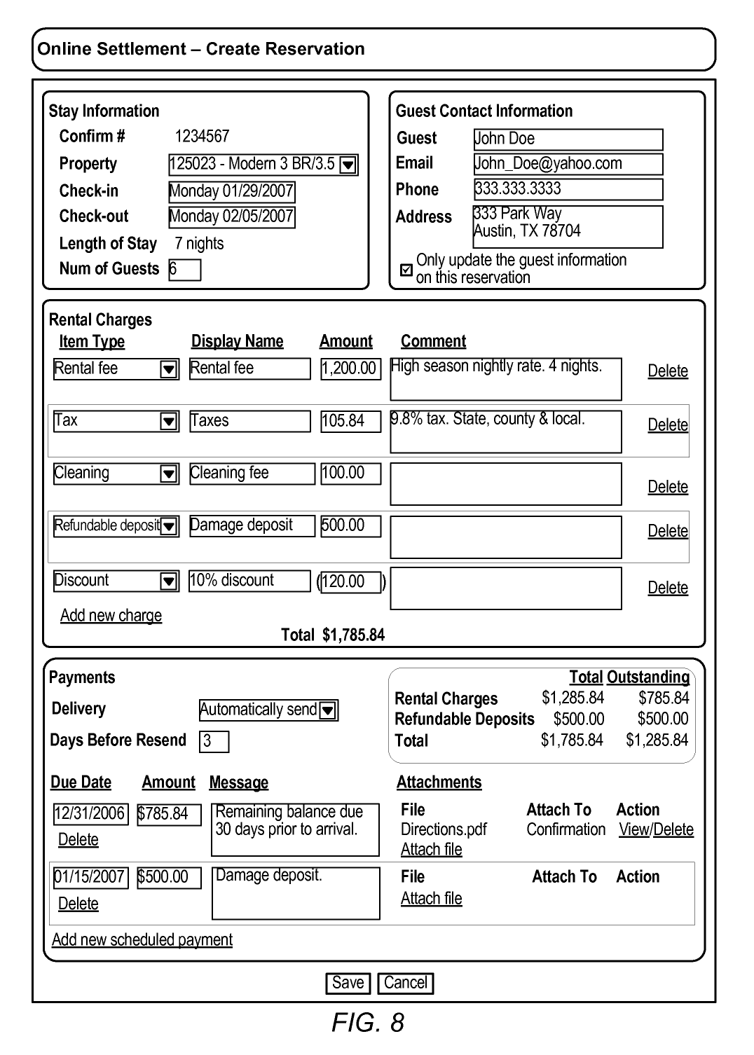

FIG. 8 is an exemplary create reservation webpage where an owner or manager may create a reservation. As indicated above, this creation may be performed automatically in response to a user creating a reservation request or may be performed by the owner or manager manually in response to a notification or contact from the user. As shown, the reservation may include stay information, guest contact information, rental charges, payments, and/or a payment plan. The owner/manager may also attach documents/images that may be sent to the user with a payment request.

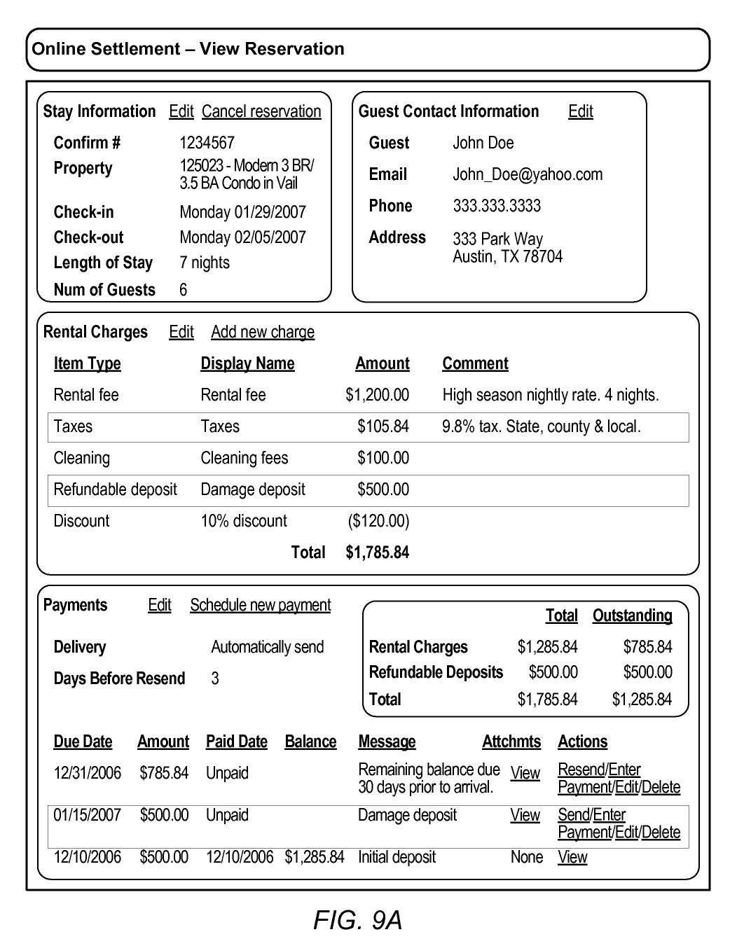

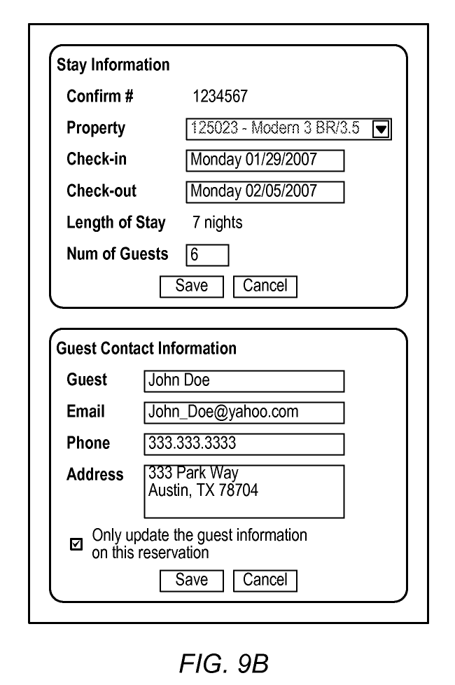

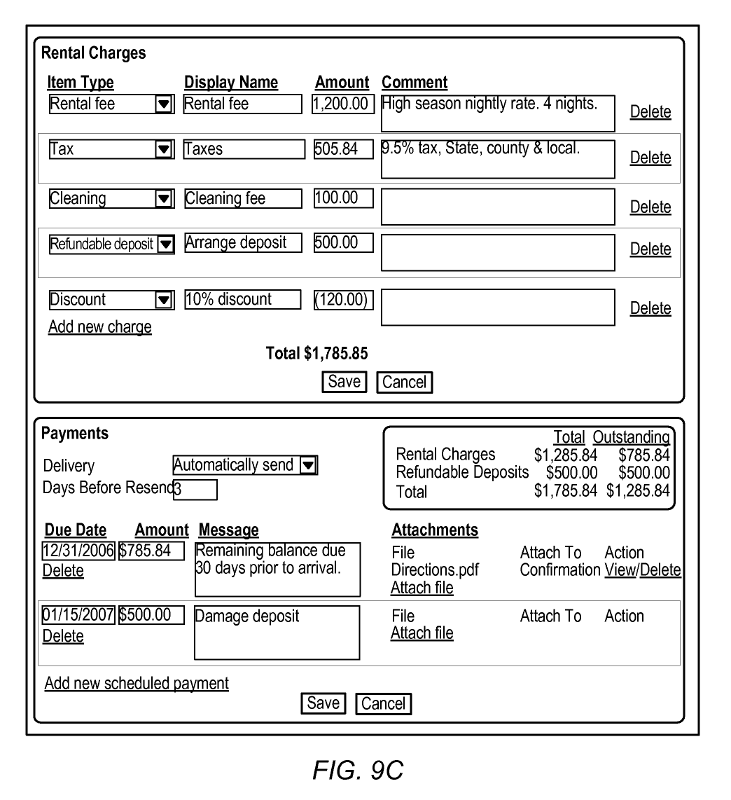

FIG. 9 is an exemplary view reservation page where an owner or manager can edit or view current reservations. As shown, the user may perform various modifications to the different portions of a reservation as desired.

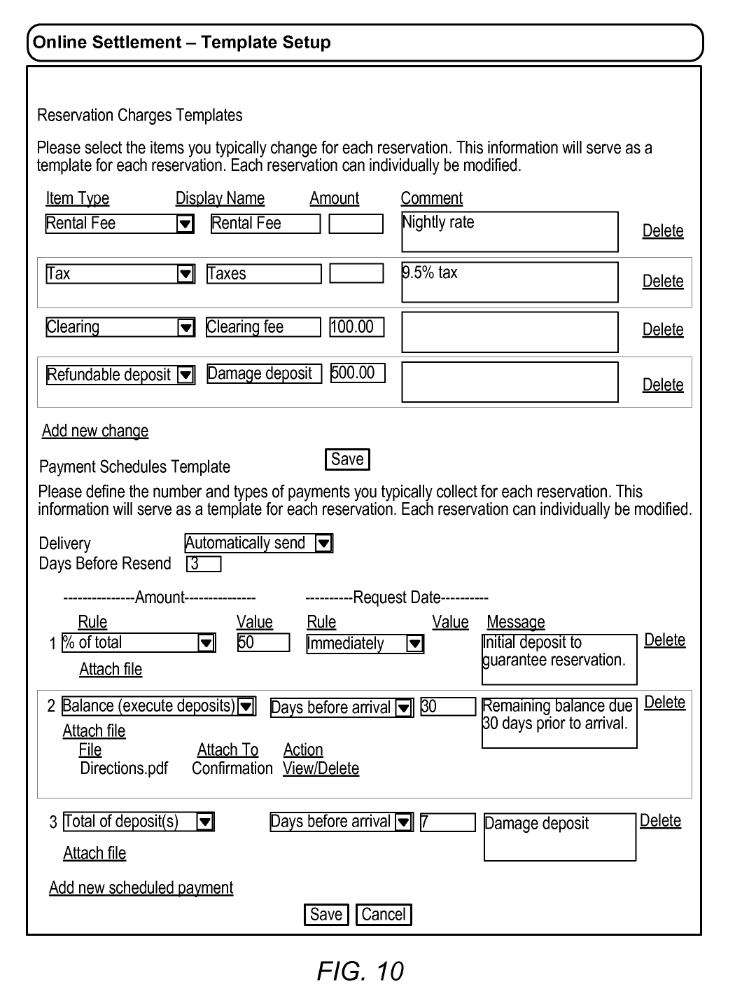

FIG. 10 is an exemplary online settlement template setup. As indicated above, payment templates (such as the one shown in FIG. 10) can be used in various reservations. Thus, the manager may simply choose an already configured payment template instead of manually configuring the payment schedule for each reservation.

Attached hereto is a presentation describing aspects of the systems and methods described herein.

Note that the above descriptions regarding vacation rental properties may apply to various other areas or fields. For example, the methods described above may apply to rental cars (or other vehicles), cruises, hotels, house boats, vacation packages, management services, and/or other industries/fields. Thus, the method described above may apply to any field where users may contact and confirm pricing information for rent or exchange.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method, comprising:
receiving first user input from a first user to a website requesting reservation of a vacation rental property, wherein the first user input comprises contact information for the first user;
providing the first user input regarding the requested reservation of the vacation rental property to a second user, wherein the contact information is usable by the second user to contact the first user;
receiving second user input specifying a reservation of the vacation rental property after said providing the first user input to the second user, wherein the reservation comprises reservation dates and a reservation price;
providing the reservation to the first user after said receiving the second user input;
storing a payment request for the reservation in a memory medium, wherein the payment request is usable for payment of the vacation rental property; and
providing the payment request to the first user to receive payment for renting the vacation rental property.

2. The method of claim 1, wherein the first user input is usable by the second user to determine one or more of:
pricing information of the reservation;
screening information of the first user;
a credit score of the first user; or
demographic information.

3. The method of claim 1, wherein the payment information comprises payment information of the first user.

4. The method of claim 1,
wherein the second user input specifying a reservation of the vacation rental property is received by the second user.

5. The method of claim 4,
wherein the second user is an owner or manager of the vacation rental property.
